(19) United States
(12) Patent Application Publication
(10) Pub. No.: US 2014/0048195 A1
(43) Pub. Date: Feb. 20, 2014

(54) APPARATUS AND METHOD FOR MANUFACTURING DISPLAY DEVICE

(71) Applicant: KABUSHIKI KAISHA TOSHIBA, Tokyo (JP)

(72) Inventors: Aisar Labibi Romas, Yokohama-shi (JP); Sei Musha, Kawasaki-shi (JP); Kentaro Miyazaki, Yokohama-shi (JP); Hirokazu Okamoto, Kawasaki-shi (JP)

(73) Assignee: KABUSHIKI KAISHA TOSHIBA, Tokyo (JP)

(21) Appl. No.: 13/836,966

(22) Filed: Mar. 15, 2013

(30) Foreign Application Priority Data
Aug. 14, 2012 (JP) 2012-179793

(51) Int. Cl. B32B 37/14; B32B 37/00

(52) U.S. Cl. CPC B32B 37/14; B32B 37/0046
USPC 156/60; 156/378

(57) ABSTRACT

An apparatus for manufacturing a display device, the apparatus includes, a displacement meter for measuring a thickness of a first substrate and a thickness of a second substrate, a drive mechanism for joining together the first substrate and the second substrate with an adhesive intervening between them by causing a first substrate retention unit and a second substrate retention unit to relatively approach each other in a predetermined relative approach speed, and a control unit for controlling the relative approach speed in accordance with a gap between the first substrate and the second substrate by means of the drive mechanism, wherein the relative approach speed is set based on reactive force generated by the adhesive dependently on applied force.

### CROSS-REFERENCE TO RELATED APPLICATIONS

This application is based upon and claims the benefit of priority from Japanese Patent Application No. 2012-179793, filed Aug. 14, 2012, the entire contents of which are incorporated herein by reference.

### FIELD

Embodiments described herein relate generally to an apparatus and a method both for manufacturing a display device.

### BACKGROUND

Manufacture of a display device includes joining together two transparent plate members (also referred to as “substrates” hereinafter). Apparatuses for joining them employ two methods, that is, a method of using an adhesive sheet, and that of using a resin adhesive. The adhesive sheet costs more than the adhesive, and therefore the method of joining them using a resin adhesive is mainly employed because of increasingly strong demands for cost reduction in recent years.

A known method of the joining is to coat a plurality of places on a contact surface of a work A with an adhesive, and cause the contact surface to contact with another sheet of the work B so as to fill the adhesive by virtue of the own weight of the work A.

### BRIEF DESCRIPTION OF THE DRAWINGS

FIG. 1 is a side view diagram illustrating a manufacture apparatus according to an embodiment, the apparatus for manufacturing a display device;

FIG. 2 is a plan view diagram illustrating the manufacture apparatus for manufacturing the display device;

FIG. 3 is a description diagram showing an operation flow related to the manufacture apparatus for manufacturing the display device;

FIG. 4 is a description diagram illustrating an operation flow in a press-in step related to the manufacture apparatus for manufacturing the display device;

FIG. 5 is a description diagram showing a downstream-side stage as a function of time in the press-in step;

FIG. 6 is a plan view diagram illustrating a lower substrate recognition step related to the manufacture apparatus for manufacturing the display device;

FIG. 7 is a plan view diagram illustrating a lower substrate recognition step related to the manufacture apparatus for manufacturing the display device;

FIG. 8 is a side view diagram illustrating a lower substrate measurement step related to the manufacture apparatus for manufacturing the display device;

FIG. 9 is a side view diagram illustrating an upper substrate measurement step related to the manufacture apparatus for manufacturing the display device;

FIG. 10 is a side view diagram illustrating a reversing step related to the manufacture apparatus for manufacturing the display device;

FIG. 11 is a side view diagram illustrating a reversing step related to the manufacture apparatus for manufacturing the display device;

FIG. 12 is a diagonal view diagram showing a partial cut view of a floating mechanism incorporated in the manufacture apparatus for manufacturing the display device;

FIG. 13 is a plan view diagram illustrating an upper substrate recognition step related to the manufacture apparatus for manufacturing the display device;

FIG. 14 is a plan view diagram illustrating the upper substrate recognition step related to the manufacture apparatus for manufacturing the display device;

FIG. 15 is a plan view diagram illustrating a downstream-side stage correction step related to the manufacture apparatus for manufacturing the display device;

FIG. 16 is a side view diagram illustrating the press-in step related to the manufacture apparatus for manufacturing the display device;

FIG. 17 is a description diagram showing an operation flow in another press-in step related to the manufacture apparatus for manufacturing the display device; and

FIG. 18 is a description diagram showing reactive force as a function of gap in the other press-in step.

### DETAILED DESCRIPTION

An apparatus for manufacturing a display device according to an embodiment, the apparatus includes: a first substrate retention unit for retaining a first substrate; a second substrate retention unit for retaining a second substrate; a displacement meter for measuring a thickness of the first substrate retained by the first substrate retention unit and a thickness of the second substrate retained by the second substrate retention unit; a drive mechanism for joining together the first substrate and the second substrate with an adhesive intervening between them by causing the first substrate retention unit and the second substrate retention unit to relatively approach each other in a predetermined relative approach speed; and a control unit for controlling the relative approach speed in accordance with a gap between the first substrate and the second substrate by means of the drive mechanism, where the relative approach speed is set based on reactive force generated by the adhesive dependently on applied force.

The following is a description of the present embodiment in detail with reference to the accompanying drawings.

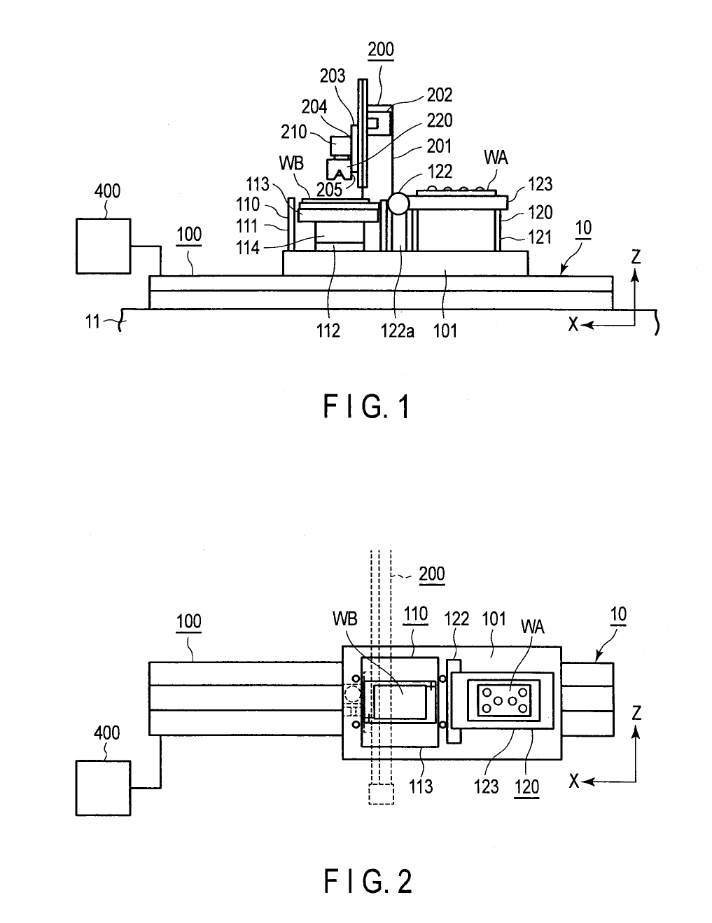

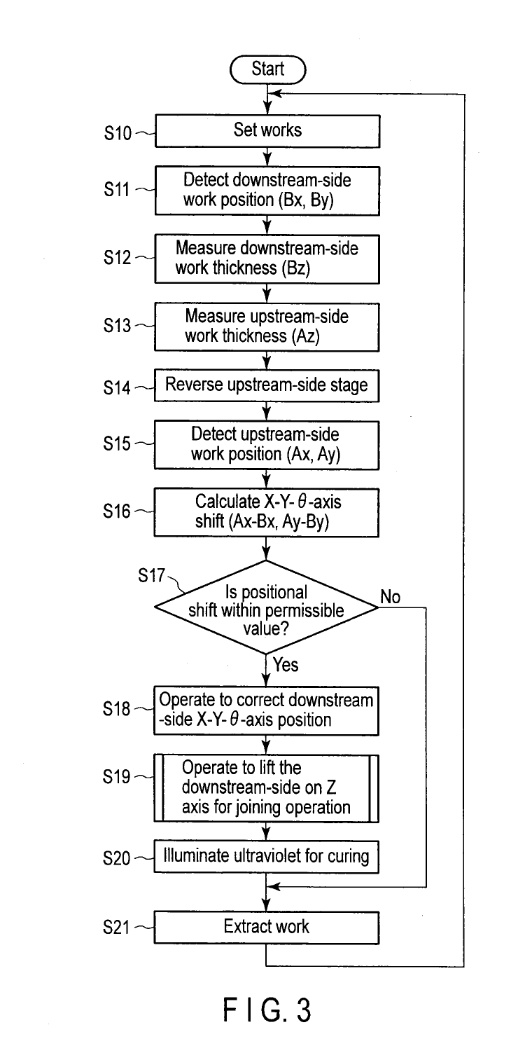

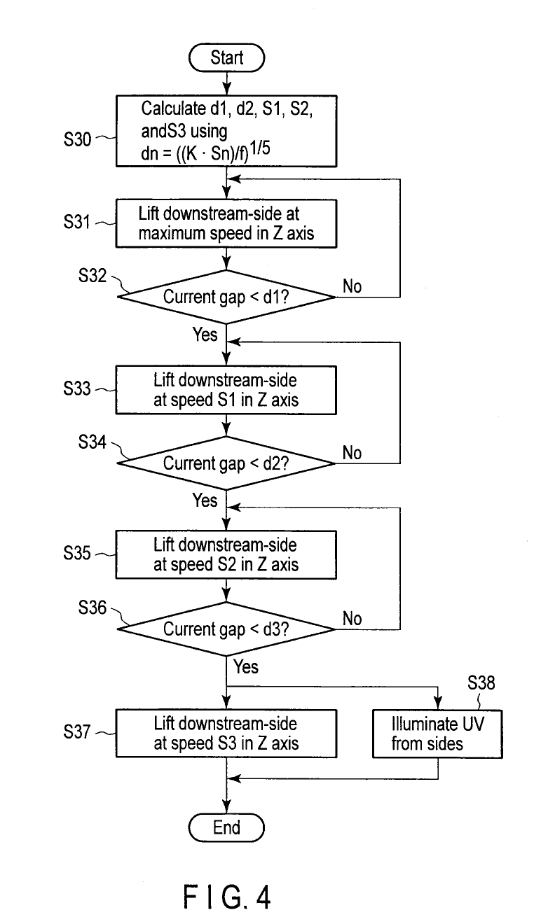

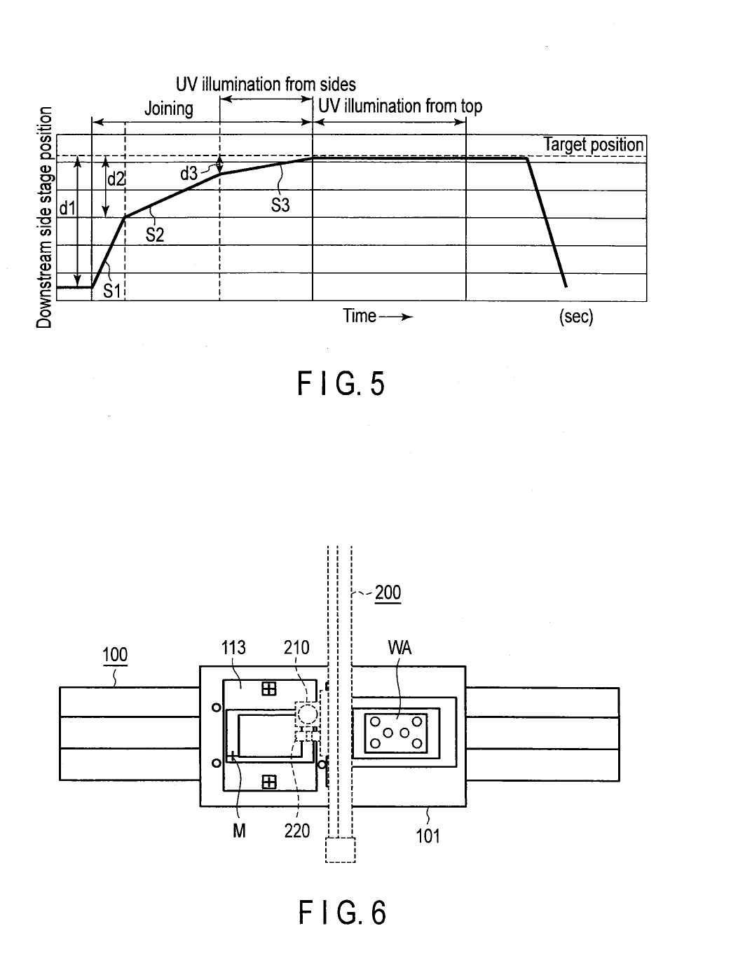

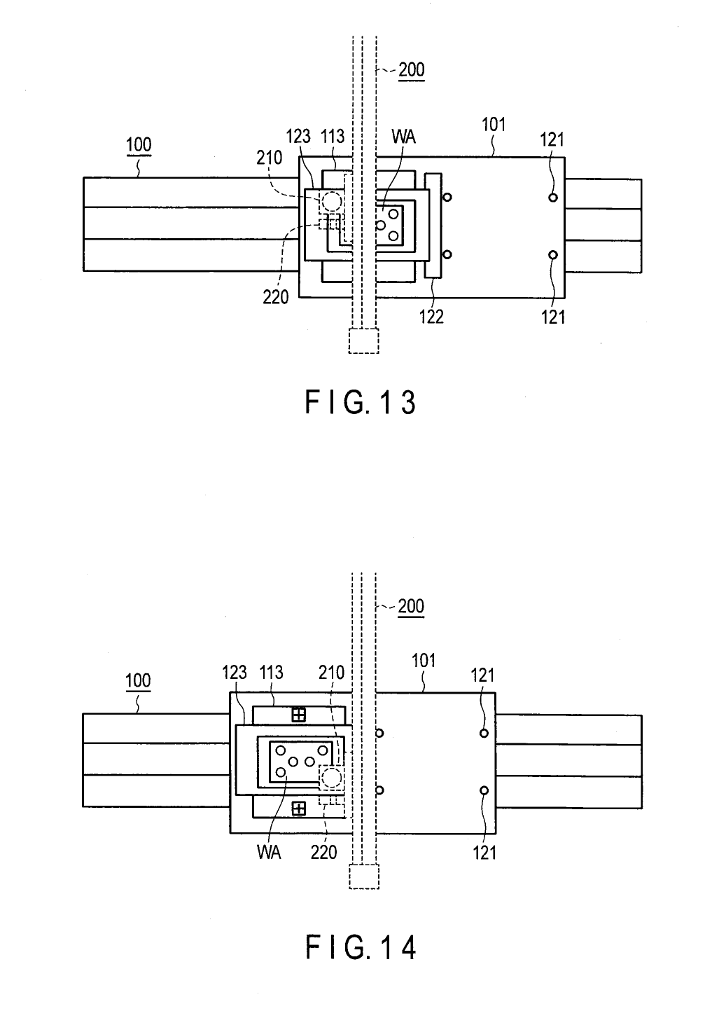

FIG. 1 is a side view diagram illustrating a joining apparatus 10 (that is equivalent to a manufacture apparatus for manufacturing a display device; this note is not given in the following descriptions) according to an embodiment of the present invention; FIG. 2 is a plan view diagram illustrating the joining apparatus 10; FIG. 3 is a description diagram showing an operation flow of the joining apparatus 10; FIG. 4 is a description diagram illustrating an operation flow in a press-in step performed on the joining apparatus 10; FIG. 5 is a description diagram showing a downstream-side stage 113 as a function of time in the press-in step; FIG. 12 is a diagonal view diagram showing a partial cut view of a floating mechanism 124 incorporated in the joining apparatus 10 for manufacturing a display device. Further, FIG. 6 through FIG. 11, and FIG. 13 through FIG. 16 are diagrams showing respective steps.

It is noted that the arrows “X”, “Y”, and “Z” shown in these figures indicate three mutually orthogonal directions, with a “X, Y” direction indicating a horizontal direction, while a “Z” direction indicating a vertical direction. Further, “θ” indicates a rotational angle around a Z direction. Further, “WA” shown in these figures indicates an upstream-side work (that is equivalent to an example of the first substrate; this note is not given in the following descriptions), while “WB” shown likewise indicates a downstream-side work (that is equivalent to an example of the second substrate; this note is not given in the following descriptions). Each of the downstream-side work WB and the upstream-side work WA is, for example, a substrate such as a cover glass, a sensor glass, a substrate of a liquid crystal module. Furthermore, an adhesive to be used is, for example, an ultraviolet-curable adhesive P.

The joining apparatus 10 is provided with a base table 11 that is stationarily placed on a floor surface. An X-direction guide mechanism 100 extending in an X direction and a measurement mechanism 200 are mounted on the base table 11. Further, the joining apparatus 10 is provided with a control unit 400 for controlling the X-direction guide mechanism 100 and the measurement mechanism 200 in connection with each other.

The X-direction guide mechanism 100 is provided with a stage 101 whose position in an X direction is determined by the X-direction guide mechanism 100.

The stage 101 is provided thereon with a lower substrate mounting mechanism 110 and an upper substrate mounting mechanism 120 in parallel with each other in the X direction.

The lower substrate mounting mechanism 110 includes: a reference support unit 111 constituted by four columns mounted onto the stage 101; an alignment mechanism 112 that is disposed at a position enclosed by the reference support unit 111 and performs alignment in X-Y-Z-θ directions; and a downstream-side stage 113 that is supported by the alignment mechanism 112 and suction-retains the downstream-side work WB.

The downstream-side stage 113 is subjected to a fine adjustment performed by the alignment mechanism 112 in X-Y-θ directions. It is noted that a drive mechanism 114 that moves up and down in the Z directions is supported by the alignment mechanism 112.

The upper substrate mounting mechanism 120 includes: a reference support unit 121 constituted by four columns disposed on the stage 101; a reverse mechanism 122 disposed between the reference support unit 111 and the reference support unit 121; and an upstream-side stage 123 that is supported by the reverse mechanism 122 and suction-retains the upstream-side work WA. The upstream-side stage 123 is configured to be allowed to freely move between on the reference support unit 121 and above the downstream-side stage 113 in a swinging manner by means of the reverse mechanism 122.

With reference to FIG. 12, the reverse mechanism 122 includes: a support column 122a; a rotation shaft 122b disposed on an upper portion of the support column 122a; and plates 122c disposed on both end portions of the rotation shaft 122b. A floating mechanism 124 intervenes between the plates 122c and the upstream-side stage 123, with the plates 122c and the upstream-side stage 123 elastically connected to each other.

The measurement mechanism 200 includes: a support column 201 disposed on the base table 11 in the Z direction; a Y-direction guide mechanism 202 extending from the support column 201 in a Y direction; and a stage 203 whose position is subjected to determination in a Y direction by the Y-direction guide mechanism 202. Further, the stage 203 supports a camera guide mechanism 204 and a laser displacement meter guide mechanism 205.

The camera guide mechanism 204 is equipped with a camera unit 210 that has a downward direction as its imaging range and is subjected to determination of a position in Z directions. As described in detail later, the camera unit 210 has functionality of recognizing respective images of marks M disposed on the downstream-side work WB and the upstream-side work WA to highly accurately measure positions of the downstream-side work WB and the upstream-side work WA. Meanwhile, the laser displacement meter guide mechanism 205 is equipped with a laser displacement meter unit 220 that has a downward direction as its measurement direction and of which a position is subjected to determination in Z directions. The laser displacement meter unit 220 has functionality of illuminating a laser beam on the downstream-side work WB and the upstream-side work WA to highly accurately measure a thickness of the work WB and that of the work WA in a noncontact manner.

On thus configured joining apparatus 10, the substrate WB and the substrate WA are joined together in accordance with the operation flows shown in FIGS. 3 and 4. First, the downstream-side work WB and the upstream-side work WA are respectively placed on the downstream-side stage 113 and the upstream-side stage 123, and are suction-retained onto the respective stages (ST10). It is noted that the downstream-side stage 113 is positionally determined by the drive mechanism 114 that moves up and down in the Z directions, and therefore a height position of the downstream-side stage 113 is detected by a value of a positional sensor in the Z direction, while the upstream-side stage 123 is abutted on the reference support unit 121, and therefore a height position of the upstream-side stage 123 is known in this event. Further, respective sizes of the downstream-side stage 113 and upstream-side stage 123 are also known, and therefore the respective height positions of the respective top surfaces of the downstream-side stage 113 and the upstream-side stage 123 are also known. Meanwhile, the adhesive P is coated on a predetermined location or locations of the upstream-side work WA.

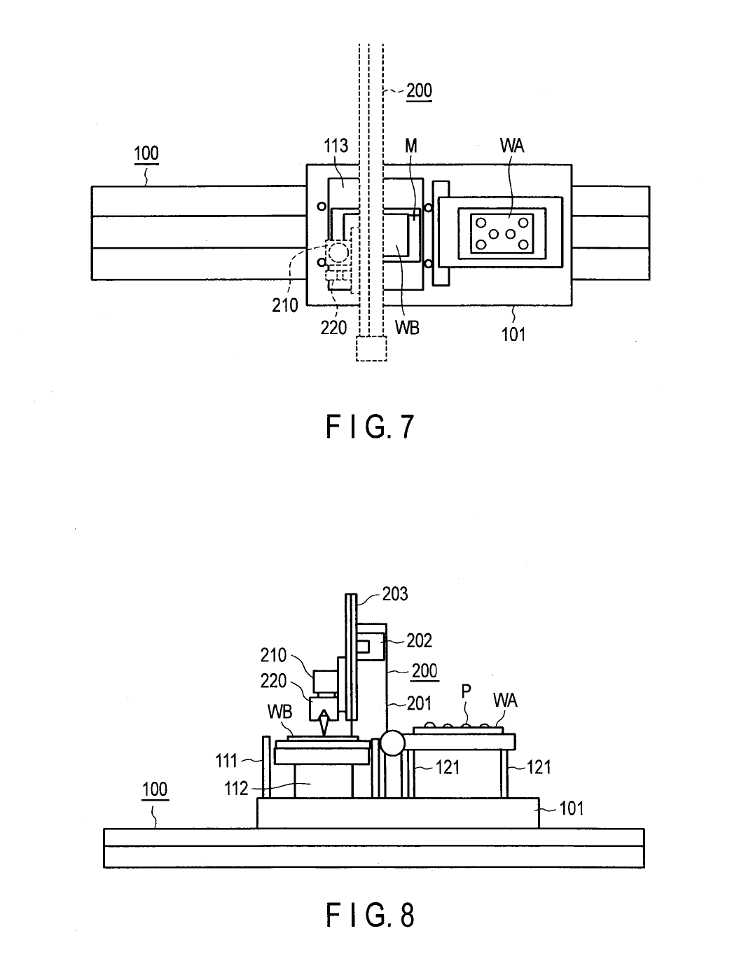

Next, as shown in FIGS. 6 and 7, the downstream-side work WB is moved to under the camera unit 210 to detect a position of the two marks M disposed on the downstream-side work WB, detecting a position (Bx, By) thereof (ST11).

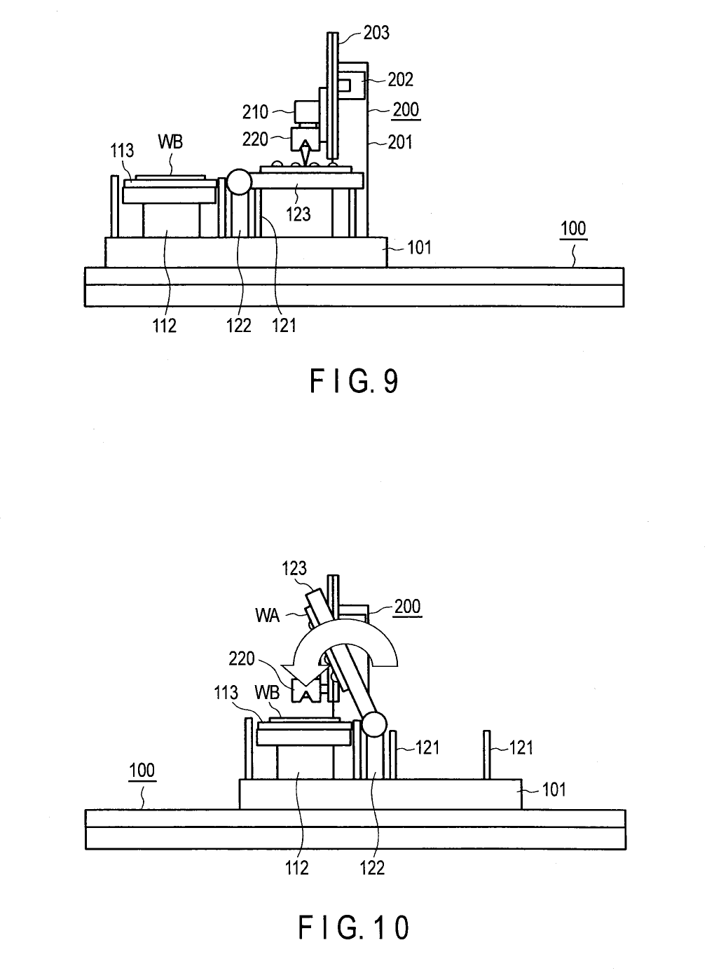

Next, as shown FIG. 8, the downstream-side work WB is moved to under the laser displacement meter unit 220 to measure a thickness (Bz) of the upstream-side work WA (ST12). Then, as shown in FIG. 9, the upstream-side work WA is moved to under the laser displacement meter unit 220 to measure a thickness (Az) of the upstream-side work WA (ST13). It is noted that the measurement of thicknesses uses, as reference, the respective height positions of the respective top surfaces of the downstream-side stage 113 and the upstream-side stage 123 as described above.

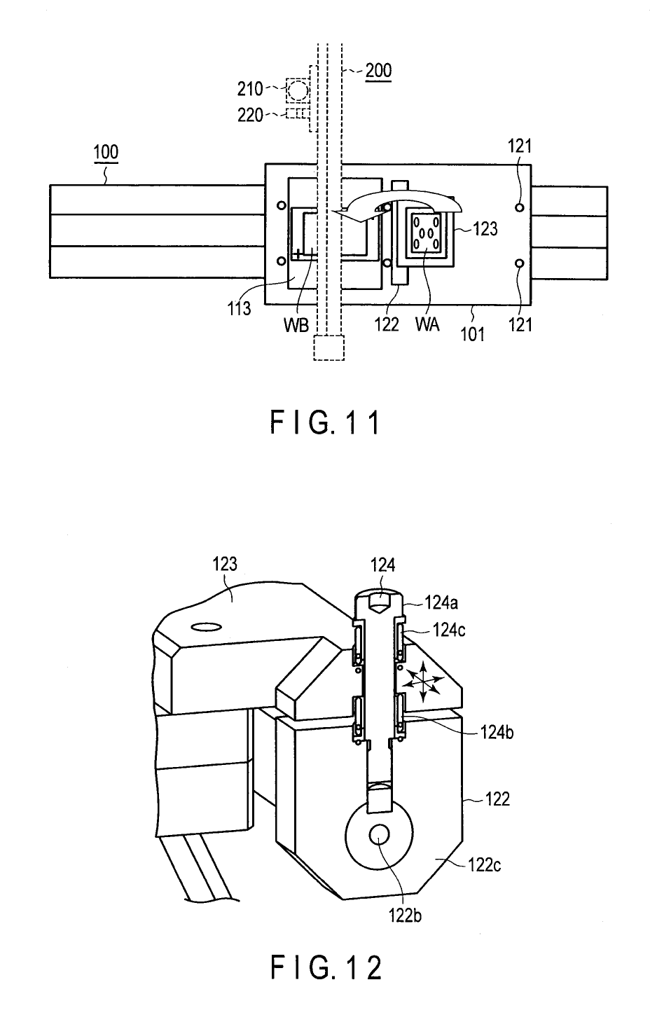

Next, as shown in FIGS. 10 and 11, the reverse mechanism 122 is operated to turn the upstream-side stage 123 to move the upstream-side work WA to above the downstream-side work WB with the upstream-side work

WA suction-retained to the upstream-side stage 123 (ST14). It is noted that, as shown in FIG. 12, the floating mechanism 124 includes: a shaft 124a disposed between the plate 122c and the upstream-side stage 123; a spring 124b for connecting the shaft 124a to the reverse mechanism 122; and a spring 124c for connecting the shaft 124a to the upstream-side stage 123.

Next, as shown in FIGS. 13 and 14, the upstream-side work WA is moved to under the camera unit 210 to detect a position of the two marks M disposed on the upstream-side work WA, detecting the position (Ax, Ay) thereof (ST15).

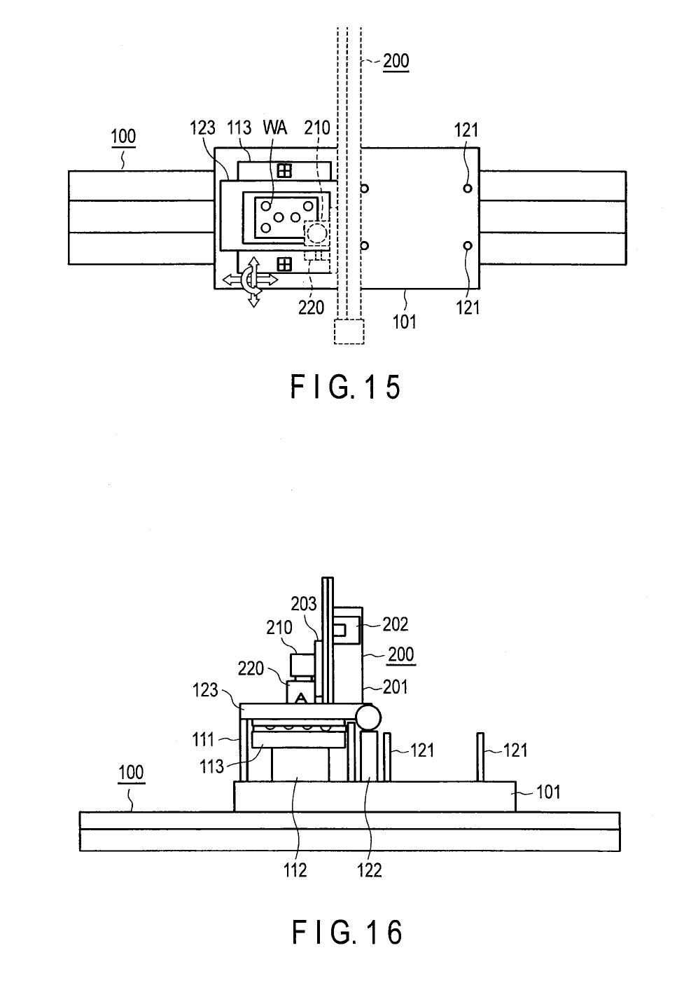

In this event, a positional shift between the downstream-side work WB and the upstream-side work WA is calculated based on the detected positional information of the marks M (ST16). Whether the positional shift is within a permissible value is determined (ST17), and, if determined to be exceeding the permissible value, the process is shifted to a step ST21 (described later). In contrast, if determined to be within the permissible value, the alignment mechanism 112 is operated to correct the positional shift in X-Y-θ axes (ST18) as shown in FIG. 15.

Upon completing correction of the positional shift, the drive mechanism 114 is operated to lift the downstream-side work WB to perform a joining operation (ST19). The joining operation is described in detail later.

Next, upon completing the joining operation, joining together the downstream-side work WB and the upstream-side work WA to produce a work W, an ultraviolet ray is illuminated on the adhesive P to provisionally cure it (ST20), and then the work W is extracted (ST21). The series of operations described above will then be repeated.

FIG. 4 shows the flow of the joining operation. For the joining operation, a design value of the gap between the downstream-side work WB and the upstream-side work WA is set at a target value G. The target value G is set at a value at which a predetermined amount of adhesive P coated between the downstream-side work WB and the upstream-side work WA is spread between them without excess or deficiency. First, using the target value G, a joining target position Q is calculated. The target position Q is given by the following expression (1):

Q=G+Az+Bz (Expression 1)

In this event, the following expression (2) is used for calculating gaps d1, d2 and d3 (which are described later) between the downstream-side work WB and the upstream-side work WA based on conditions such as the viscosity of the using adhesive and an amount of coating so that a value of press-in reactive force f from the adhesive, the reactive force generated in the work will not exceed a predetermined permissible value, and thereby approach speeds S1, S2 and S3 applied between the downstream-side work WB and the upstream-side work WA are calculated, the speeds respectively corresponding to the gaps d1, d2 and d3 (here, the approach speeds S1, S2 and S3 can be determined to be the relative approach speeds between the downstream-side work WB and the upstream-side work WA) (ST30).

dn=((K·Sn)/f)^{1/5} (Expression 2),

(where “n” is an integer equaling to or exceeding “1”, and “K” is a constant determined for each coating condition based on viscosity, volume and the like of the adhesive P)

Then the drive mechanism 114 is operated to ascend at a predetermined speed (e.g., 5 to 10 mm per sec.) (ST31). When a current gap k to the target position Q is smaller than a predetermined gap d1 (ST32), the ascending speed is decreased to the approach speed S1 (e.g., 1 to 5 mm per sec.) (ST33).

Then, when the current gap k is smaller than a predetermined gap d2 (ST34), the ascending speed is further decreased to the approach speed S2 (e.g., 0.01 to 0.1 m per sec.) (ST35). Then, when the current gap k is smaller than a predetermined gap d3 (ST36), the ascending speed is further decreased to the approach speed S3 (e.g., 0.00 to 0.01 m per sec.) (ST37). Further, substantially simultaneously with this event, in ST37, ultraviolet rays are illuminated from the sides between the downstream-side work WB and the upstream-side work WA to cure the adhesive P coming out from between the downstream-side work WB and the upstream-side work WA (ST38). Then, when the target position is reached, the joining operation is completed.

The present embodiment is configured to use the above described expression 2 so as to suppress the press-in reaction force f from exceeding the predetermined permissible value during the operation of joining together the substrates, the reactive force from the adhesive, the force generated in the work, in calculating a (relative) approach speed to be applied between the downstream-side work WB and the upstream-side work WA based on the gap between them. Accordingly, the present embodiment is configured to use the control unit 400, with the intervention of the drive mechanism 114, for controlling the movement of the downstream-side work WB and the upstream-side work WA by so that such (relative) approach speed is acquired in performing the operation for joining together the works.

This configuration makes it possible to effectively joining together the downstream-side work WB and the upstream-side work WA with the predetermined amount of the adhesive P intervening between them without excess or deficiency.

As described above, the joining apparatus 10 according to the present embodiment is configured to join together the downstream-side work WB and the upstream-side work WA by decreasing the (relative) approach speed as the current gap k between them decreases, thereby preventing excessive reactive force from exerting to the work or the apparatus and thus preventing an adverse influence thereon. Therefore, the joining apparatus 10 is capable of performing a high-quality joining operation with the thickness of the adhesive layer highly accurately controlled, and also minimizing influences on the product and the apparatus.

Further, the provision of the reverse mechanism 122 requires only one camera unit 210 and one laser displacement meter unit 220, thus reducing the cost. Further, the use of the same camera unit 210 and laser displacement meter unit 220 to respectively determine a position and measure a thickness enables highly accurate measurements. It is appreciated that a similar joining operation can be performed even without providing the reverse mechanism 122.

Further, the above described joining apparatus 10 changes the ascending speed in three steps, an alternative configuration, however, may change the speed in two steps, or four steps. In such a case, an increase in the number of steps can shorten the time to reach the target position Q.

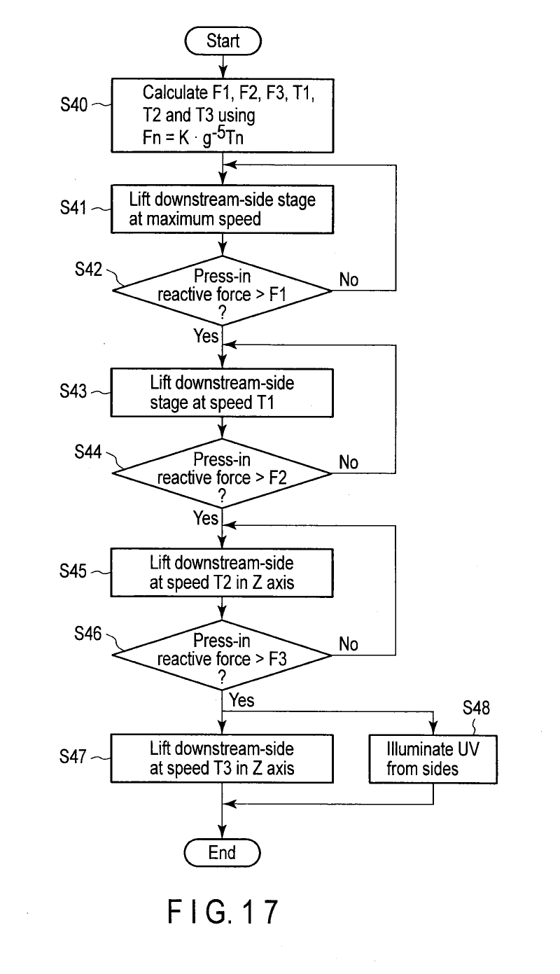

Next, another exemplary joining operation is described in accordance with the operation flow shown in FIG. 17. First, the following expression (3) is used for calculating magnitudes of press-in reactive force F1, F2 and F3, and acquiring approach speeds T1, T2 and T3 applied between the downstream-side work WB and the upstream-side work WA, the speeds respectively corresponding to the aforementioned reactive force until reaching a target position g based on conditions such as viscosity and coating amount of an adhesive that is used (here, the approach speeds T1, T2 and T3 can be determined to be relative approach speeds applied between the downstream-side work WB and the upstream-side work WA) (ST40).

Fn=K·g⁻⁵Tn (Expression 3),

(where “n” is an integer equaling to or exceeding “1”, and “K” is a constant determined for each coating condition based on viscosity, volume, and the like, of the adhesive P)

Then, the drive mechanism 114 is operated to ascend at a predetermined speed (e.g., 5 to 10 mm per sec.) (ST41). In this event, the press-in reactive force f currently exerted on the upstream-side work WA is detected with a force sensor or the like.

When the press-in reactive force f exceeds a predetermined magnitude F1 (ST42), the ascending speed is decreased to an approach speed T1 (e.g., 1 to 5 mm per sec.) with which the drive mechanism is operated to ascend (ST43).

Next, press-in reactive force f currently exerted to the upstream-side work WA is measured with a force sensor or the like, and when the current press-in reactive force f exceeds a predetermined magnitude F2 (ST44), the ascending speed is further reduced to an approach speed T2 (e.g., 0.01 to 0.1 m per sec.) with which the drive mechanism is operated to ascend. Then, press-in reactive force f currently exerted to the upstream-side work WA is measured with a force sensor or the like, and when the current press-in reactive force f exceeds a predetermined magnitude F3 (ST46), the ascending speed is further reduced to an approach speed T3 (e.g., 0.00 to 0.01 m per sec.) with which the drive mechanism is operated to ascend (ST47). Further, substantially simultaneously with this event, in ST47, ultraviolet rays are illuminated from the sides between the downstream-side work WB and the upstream-side work WA to cure the adhesive P coming out from between the downstream-side work WB and the upstream-side work WA (ST48). Then, when the target position is reached, the joining operation is completed. The present embodiment is configured to appropriately detect press-in reactive force f from the adhesive, the force generated in the work, and use the above described expression (3) so as to suppress the press-in reactive force f from exceeding a predetermined permissible value during the operation of joining together the substrates in calculating a (relative) approach speed applied between the downstream-side work WB and the upstream-side work WA. Accordingly, the present embodiment is configured to use the control unit 400, with the intervention of the drive mechanism 114, for controlling the movement of the downstream-side work WB and the upstream-side work WA by so that such (relative) approach speed is acquired in performing the operation for joining together the works.

The other exemplary joining operation of the present embodiment also makes it possible to efficiently join together the downstream-side work WB and the upstream-side work WA, with the predetermined amount of the adhesive P intervened between them without excess or deficiency.

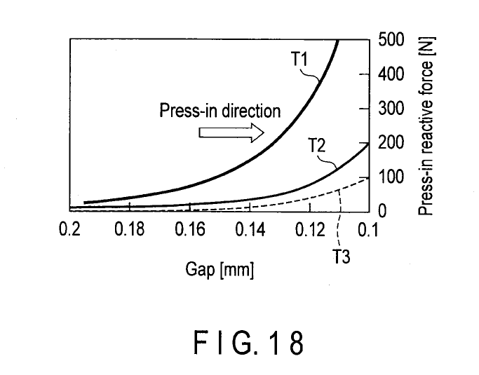

FIG. 18 is a graph showing the press-in reactive force f as a function of gap g. The press-in reactive force f rapidly increases as the gap g narrows, and therefore it should be understood that the ascending speed must be reduced to T2 or T3 in order to prevent the press-in reactive force f from exceeding, for example, 200 [N].

As described above, the joining apparatus 10 according to the present embodiment is configured to join together the downstream-side work WB and the upstream-side work WA by decreasing the approach speed as the press-in reactive force f exerted between them, thereby preventing excessive magnitude of the reactive force from exerting to the work or apparatus, causing no adverse influences thereto.

Therefore, it is possible to highly accurately control the thickness of the adhesive layer in performing a high-quality joining and minimizing adverse influence on the product and the apparatus.

According to the present invention, a liquid crystal display device and an organic electro-luminescent (EL) display device may be exemplified as the display device, while the adhesive allows usage of any adhesive materials that are within the scope and spirit of the invention.

While certain embodiments have been described, these embodiments have been presented by way of examples only, and are not intended to limit the scope of the invention. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for manufacturing a display device, the apparatus comprising:
a first substrate retention unit for retaining a first substrate;
a second substrate retention unit for retaining a second substrate;
a displacement meter for measuring a thickness of the first substrate retained by the first substrate retention unit and a thickness of the second substrate retained by the second substrate retention unit;
a drive mechanism for joining together the first substrate and the second substrate with an adhesive intervening between them by causing the first substrate retention unit and the second substrate retention unit to relatively approach each other in a predetermined relative approach speed; and
a control unit for controlling the relative approach speed in accordance with a gap between the first substrate and the second substrate by means of the drive mechanism,
wherein the relative approach speed is set based on reactive force generated by the adhesive dependently on applied force.

2. The apparatus for manufacturing a display device according to claim 1,
wherein the first substrate retention unit is a reversing unit on which a top of the first substrate and a bottom of thereof are reversed between measurement by the displacement meter and approaching by the drive mechanism.

3. The apparatus for manufacturing a display device according to claim 1, wherein the relative approach speed is set based on a gap between the first substrate and the second substrate so that the reactive force does not exceed a predetermined value.

4. The apparatus for manufacturing a display device according to claim 3,
wherein the relative approaching speed is calculated by the following expression:
dn=((K·Sn)/f)^{1/5}
where:
f: the reactive force,
dn: a gap between the first substrate and the second substrate, and
Sn: a relative approach speed between the first substrate and second substrate
(where “n” is an integer equaling to or exceeding “1”, and “K” is a constant determined for each coating condition based on viscosity, volume, and the like, of the adhesive P).

5. The apparatus for manufacturing a display device according to claim 1, further comprising detection unit configured to detect the reactive force at least at either of the first substrate and the second substrate,
wherein the control unit controls the relative approach speed based on the gap so as to control the reactive force to be equal to or less than a predetermined value.

6. The apparatus for manufacturing a display device according to claim 5,
wherein the relative approach speed is calculated by the following expression:
Fn=K·g⁻⁵Tn
where:
g: a gap between the first substrate and the second substrate,
Fn: the reactive force, and
Tn: a relative approach speed between the first substrate and the second substrate
(where “n” is an integer equaling to or exceeding “1”, and “K” is a constant determined for each coating condition based on viscosity, volume, and the like, of the adhesive P).

7. A method for manufacturing a display device, comprising:
using the apparatus for manufacturing a display device according to claim 1;
coating at least either one of the first substrate and the second substrate with the adhesive; and
causing the first substrate retention unit and the second substrate retention unit to approach each other at a predetermined approach speed in accordance with a gap between them to join together the first substrate and the second substrate with the adhesive intervening between them,
wherein the relative approach speed is set based on reactive force generated by the adhesive dependently on applied force.
